(19) United States
(12) Patent Application Publication
(10) Pub. No.: US 2013/0246132 A1
(43) Pub. Date: Sep. 19, 2013

(54) SMART TRANPORTATION SERVICES & PAYMENT SYSTEM AND METHOD

(71) Applicant: David J. BUIE, Washington, DC (US)

(72) Inventor: David J. BUIE, Washington, DC (US)

(21) Appl. No.: 13/839,841

(22) Filed: Mar. 15, 2013

Related U.S. Application Data
(60) Provisional application No. 61/612,310, filed on Mar. 17, 2012.

(51) Int. Cl. G06Q 20/20

(52) U.S. Cl. CPC G06Q 20/20
USPC 705/13

(57) ABSTRACT

A method and system for paying for transportation and/or transportation support services and providing member services associated with the transportation is provided. The method includes relating a member-user to a given transportation service entity by Smartphone (iPhone, Android, or similar), Cellular phone, Special Debit Card/Smart Card, registered LPR, RFID, etc. The method further includes automatically debiting an established “Transportation Replenishing Member Payment Account” with funds to pay a transportation support service entity, and invoking one or more member services, in addition to crediting the TRMPA upon redemption of an authorized/authenticated parking credit or special offer.

This application claims the benefit of U.S. Provisional Application No. 61/612,310, filed Mar. 17, 2012, which is hereby incorporated by reference in its entirety.

### BACKGROUND

1. Field of the Invention

The present invention relates generally to the purchase of and payment for goods and services, and more particularly to a variety of defined services and software applications related to transportation services such as shared garage parking, public transportation methods, car-share, bike-share, or curb-side street parking, and the like and the capability for businesses and/or entities to subsidize all or part of a given service fee.

2. Description of Related Art

Transportation methods vary greatly between users and the related costs are disparate and typically budgeted by individuals. Transportation payment methods are diverse and often antiquated, and often do not offer any advanced or intelligent services or advertising opportunities.

For example, traditional “User-Payment” processes are still widely utilized to initiate and/or deliver payment for future time required for parking an automobile in public and/or private spaces. Typical traditional parking meters and parking garages require pre-payment or post-payment of fees at the point of service as “rent” for periods of tracked time. Payment types include coin, cash and/or credit cards. These payments suggest an immediate transfer from a user or financial institution of an amount of currency directly applied to the owner/manager of the meter technology or Parking Service Provider.

The monitoring of the time remaining on a parking meter or with a parking facility is still largely performed by an individual manually traveling to each parking space and checking the time remaining on the associated parking meter or by gated enter/exit time-ticketing methods. These methods are both time-consuming and inefficient.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description. In certain embodiments, the disclosed embodiments may include one or more of the features described herein.

Establishment of a new specific transportation account with payment capabilities towards a defined network of transportation-related services introduces a common process from which users may apply a flexible variety of convenient payment methods and rewards. This account may be leveraged to offer a broad array of member-services to member-users while introducing a platform to provide operational features and business intelligence to transportation services companies/entities. Additionally, the establishment of this account with member-users creates new opportunities to local businesses for the offering of customer rewards or loyalty programs where “transportation credits” are presented that apply to the transportation account, which may be correlated to eligible transportation transactions, such as a parking transaction in an eligible parking garage on the same day as a purchase from a retail business. This platform also yields business intelligence applicable to the local businesses and others.

In accordance to an embodiment of the invention, a system is provided. The system includes one or more physical processors and storage media storing machine-readable instructions that cause the one or more physical processors to receive, via a transportation service provider point-of-service device, information pertaining to a transportation service transaction, receive user account identifying information associated with the transportation service transaction, determine a user account associated with the user account identifying information, authenticate the user account identifying information, and, responsive to successful authentication of the user account identifying information, invoke one or more user-specific member services associated with the identifying information-associated user account and debit the identifying information-associated user account to pay for a service provided by the transportation service provider. Authentication may involve requesting or gathering a password or other secondary form of identification from a member-user whose account is determined to be associated with the user account identifying information.

In accordance to an embodiment of the invention, a method is provided. The method includes receiving, via a transportation service provider point-of-service device, information pertaining to a transportation service transaction, receiving user account identifying information associated with the transportation service transaction, determining a user account associated with the user account identifying information, authenticating the user account identifying information, responsive to successful authentication of the user account identifying information, invoking one or more user-specific member services associated with the identifying information-associated user account and debiting the identifying information-associated user account to pay for a service provided by the transportation service provider, receiving, via a business credit device, a request for credit comprising a unique device identifier, determining a business-user account associated with the unique device identifier, establishing a transaction and associating system-created information and business-user defined information with the transaction, where the information associated with the transaction comprises details of a user account credit, receiving a request to apply the credit associated with the transaction to a requested user account, determining whether and how to apply the credit to the requested user account based on parking services payment transaction information associated with the requested user account, and, responsive to a determination to apply the credit to the requested user account in a certain manner, applying the credit accordingly.

In accordance to another embodiment of the invention, a method is provided. The method includes establishing an authenticated or secure relationship between a network-member garage or other member transportation service and a given registered user “member account” for purpose of invoking predefined “member services” to include, but not limited to, payment of parking or other fees. The method includes communicating through available internet, cellular, or other data communications with system software to establish the relationship between the member-user account and the specific transportation service. This method further establishes the control processes used to remotely monitor and/or adjust metered time or related parking/transportation information.

In one embodiment, the method includes receiving, by a transportation service entity such as a parking garage service provider or curbside terminal device, through associated telemetry, an identification code, and associating the identification code with a user account and authenticating the identification code. The method further includes automatically debiting the user account with funds to pay for a service provided by the transportation service entity, and invoking one or more member services associated with the debit in response to authenticating the identification code.

In accordance to another embodiment of the invention, a system is provided. The system includes a processor and a memory containing a program, which, when executed by the processor, is configured to perform an operation. The operation includes receiving and processing, by system software and/or by a curbside terminal device, an identification code, and associating the identification code with a user account and authenticating the identification code. The operation further includes automatically debiting the user account with funds to pay for a service provided by the transportation service entity, and invoking one or more member services associated with the debit in response to authenticating the identification code.

In accordance to yet another embodiment of the invention, a computer-readable storage medium including a program, which when executed on a processor performs an operation. The operation includes receiving, by a transportation service entity such as a parking garage service provider or curbside terminal device, an identification code, and associating the identification code with a user account and authenticating the identification code. The operation further includes automatically debiting the user account with funds to pay for a service provided by the transportation services entity, and invoking one or more member services associated with the curbside terminal device in response to authenticating the identification code.

### BRIEF DESCRIPTION OF THE DRAWINGS

The invention may be understood by reference to the following description taken in conjunction with the accompanying drawings, which are incorporated herein and form a part of the specification, and in which:

FIG. 1 shows a block diagram illustrating a server computer coupled to a network according to one embodiment of the present invention.

FIG. 2 shows a block diagram illustrating a portal client (designed for a specific user-audience e.g. government, consumer, and/or business audience) coupled to a network according to one embodiment of the present invention.

FIG. 3 shows a block diagram illustrating mobile devices coupled to a network according to one embodiment of the present invention.

FIG. 4 shows a block diagram illustrating a curbside terminal coupled to a network according to one embodiment of the present invention.

FIG. 5 shows a block diagram illustrating a business credit device according to one embodiment of the present invention.

FIG. 6 shows a block diagram illustrating a parking garage service provider coupled to a network according to one embodiment of the present invention.

FIG. 7 illustrates a method of processing payment for transportation services and concomitantly invoking user-defined member services and processing payment credits from participating businesses, according to an embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but, on the contrary, the intention is to cover all modifications, equivalents, and alternatives falling within the spirit and scope of the invention as defined by the appended claims.

### DETAILED DESCRIPTION

A new smart transportation support system and method will now be disclosed in terms of various exemplary embodiments. This specification discloses one or more embodiments that incorporate features of the invention. The embodiment(s) described, and references in the specification to “some embodiments”, “one embodiment”, “an embodiment”, “an example embodiment”, etc., indicate that the embodiment(s) described may include a particular feature, structure, or characteristic. Such phrases are not necessarily referring to the same embodiment(s). When a particular feature, structure, or characteristic is described in connection with an embodiment, persons skilled in the art may effect such feature, structure, or characteristic in connection with other embodiments whether or not explicitly described.

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

Embodiments of the present invention will now be described with reference to the attached figures. Various structures, connections, systems and devices are schematically depicted in the drawings for purposes of explanation only and so as to not obscure the disclosed subject matter with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

In embodiments, a remote system may have three different types of members: member-users, member-businesses, and member-providers. The member-users may be people (or companies, etc.) who pay for transportation services. The member-businesses may be businesses or other organizations that offer transportation credits to customers/patrons. The member-providers may be transportation service providers that receive payment for transportation services such as metered or garage parking. The remote system may manage the relationship and interactions between these three types of members and provide customized member services for each. The remote system may establish payment accounts for the members-users, make payments from the member-user payment accounts to the member-providers, and issue credits to member-user payment accounts from member-businesses, according to authenticated requests made by the different members. The remote system may handle such transactions and interactions according to preferences set by each member, for example through an online member portal.

Each member may be assigned an identifier for identification purposes. Some members may have sub-identifiers, for example a member-business could have sub-identifiers for each location of the business, member-providers may have sub-identifiers for each location where it provides transportation services, etc. A member-user may associate several vehicles (e.g. family vehicles, or business fleet vehicles) with the member-user's identifier. Thus, a member-user may drive any of the associated vehicles and be identified thereby. An additional charge may be incurred if two of the associated vehicles utilize transportation services at the same time- for example if the member-user drives one vehicle and a family member drives another.

The member-providers together may make up a provider-network. Although each member-provider may be a separate entity, together they may support unified member services. Displays of participating member-providers may be displayed to member-users on maps, etc., so that they know which locations support member service invocation via the remote system. Member-user preferences may be carried with the member-user from one member-provider to another.

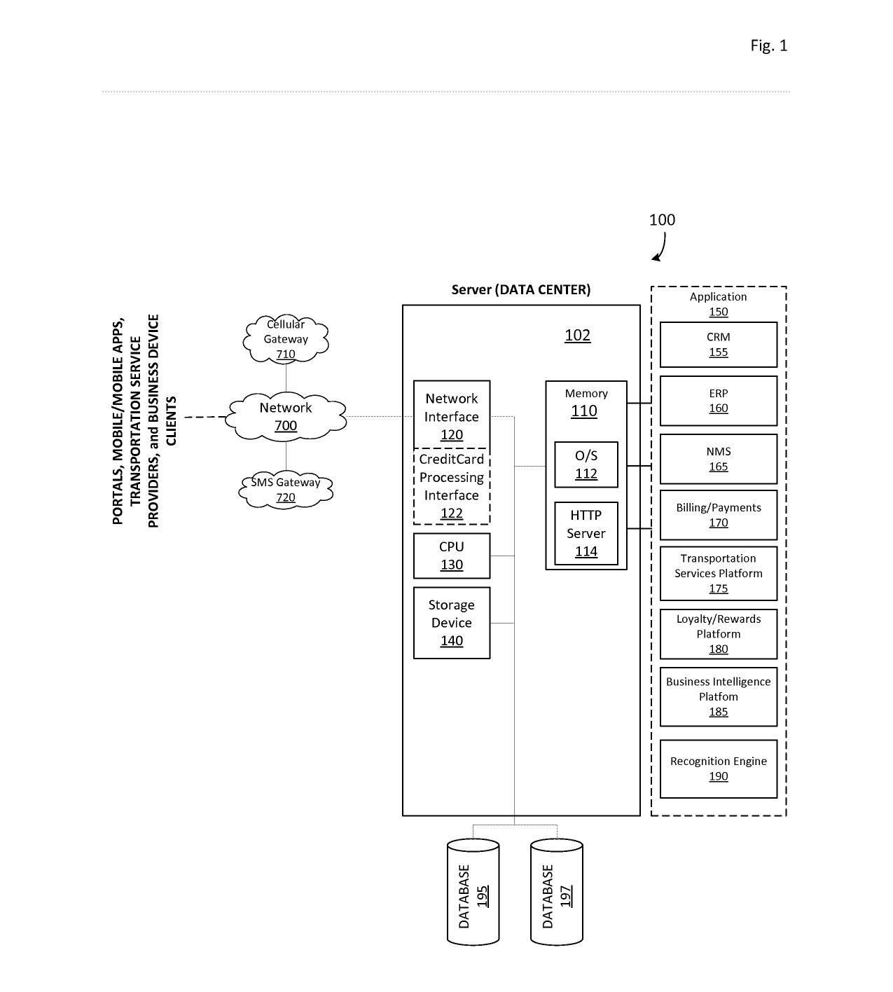

One embodiment of the invention is implemented as a program product for use with a computer system such as, for example, the computing environments 100, 200, 300, 400, 500, 600 shown in FIGS. 1, 2, 3, 4, 5, 6 respectively and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive, solid state storage devices); and (iii) information conveyed to a computer by a communications medium, such as through a computer or telephone network, including wireless communications. The latter embodiment specifically includes information downloaded from the Internet and/or other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in one or more specific embodiments of the invention. However, it should be appreciated that any particular program nomenclature that follows is used merely for convenience, and thus the invention should not be limited to use solely in any specific application identified and/or implied by such nomenclature. In this regard, references to particular definitional languages, such as HTML and XML, are illustrative in nature and do not serve to limit the claims. It is broadly contemplated that the invention is applicable regardless of the particular schema and/or language used to define network resource content.

Apparatus, systems, software applications and methods that define “user-payment” vs. new “user-identification” processes that may be introduced to invoke member-services for consumers and businesses for a variety of defined services related to transportation, and the relationship the model establishes between consumers, businesses, parking facility operators, public transportation entities, and local governments are described herein.

The apparatus, systems, and methods establish a new method of payment that may be utilized to initiate and/or complete secure payment process, and additionally invoke unique member-services through identification of a “member-user” as a component of the transaction is provided herein.

Turning now to FIG. 1, a block diagram illustrating an exemplary computing environment 100, in accordance with an embodiment of the present invention, is illustrated. Specifically, a server computer (e.g., a data center) 102 is shown coupled to a network 700, such as the Internet, an intranet, a local area network (LAN) and/or the like.

As shown, the server computer 102 may include a CPU 130, a memory 110, a network interface device 120, and/or a storage device 140, coupled via a bus. The CPU is configured to provide information processing capabilities. As such, the CPU may include one or more of a digital processor, an analog processor, a digital circuit designed to process information, an analog circuit designed to process information, a state machine, and/or other mechanisms for electronically processing information. Although the CPU is shown as a single entity, this is for illustrative purposes only. In some implementations, the CPU may include a plurality of processing units. These processing units may be physically located within the same device, or the CPU may represent processing functionality of a plurality of devices operating in coordination. In embodiments, the CPU may be configured to perform disclosed operations by software; hardware; firmware; some combination of software, hardware, and/or firmware; and/or other mechanisms for configuring processing capabilities on the processor.

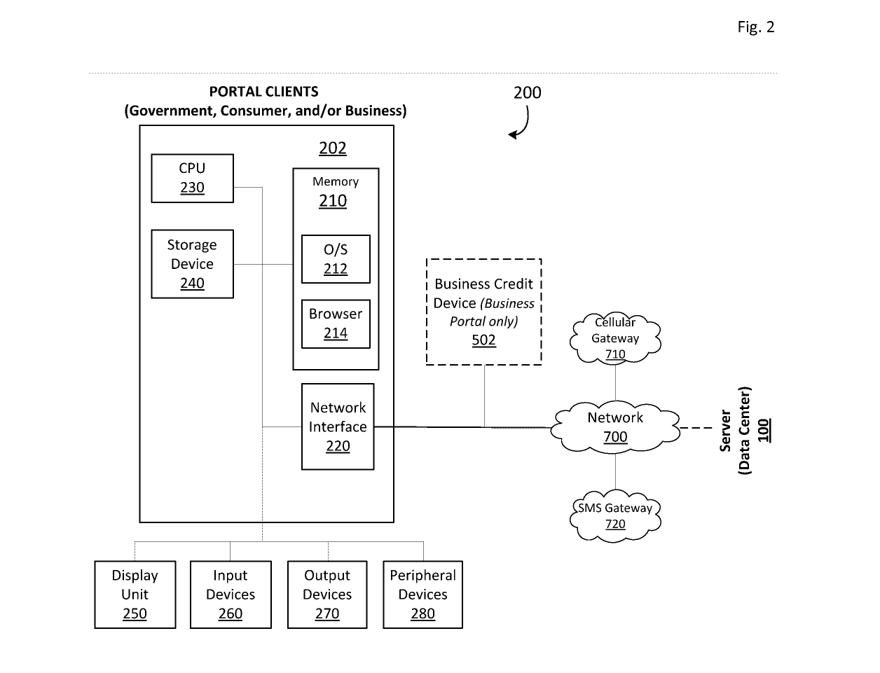

The memory 110 may be, in accordance with one or more embodiments, a random access memory sufficiently large to hold the necessary programming and data structures that are located on the server computer 102. As shown, the memory 110 may store an operating system (O/S) 112 used to manage server hardware and/or software executing on the server computer 102. Illustratively, the memory 110 may also include a hypertext transfer protocol (http) server 114 that may be configured to service requests from a client computer 202, 302, 402, 502 (as shown in FIGS. 2, 3, 4, and 5, respectively). For example, the http server 114 may respond to requests for access to electronic resources (e.g., HTML documents, network information, and/or the like) residing on the server computer 102. However, one of ordinary skill in the art will recognize that the http server 114 is merely illustrative and embodiments of the invention may be adapted to support both known and unknown protocols. The programming and data structures of the http server 114 may be accessed and executed by the CPU 130 as needed during operation. The server computer 102 may connect to the network 700 using the network interface device 120 (e.g., an analog modem, a wired network card, a wireless network device, and/or the like).

The server computer 102 may also include a customer relationship management (CRM) system 155, an enterprise resource planning (ERP) system 160, a network management system (NMS) 165, a billing/payment system 170, a Transportation Services Platform 175, a Loyalty/Rewards Platform 180, a Business Intelligence Platform 185, and/or a Recognition engine 190. In one embodiment, the CRM system 155, the ERP system 160, the NMS 165, the billing/payment system 170, the Transportation Services Platform 175, the Loyalty/Rewards Platform 180, The Business Intelligence Platform 185, and/or the Recognition engine 190 are located in the memory 110. In another embodiment, the CRM system 155, the ERP system 160, the NMS 165, the billing/payment system, the Transportation Services Platform 175, the Loyalty/Rewards Platform 180, the Business Intelligence Platform 185, and/or the Recognition engine 190 are located on another computing system (not shown). The CRM system 155, the ERP system 160, the NMS 165, the billing/payment system 170, the Transportation Services Platform 175, the Loyalty/Rewards Platform 180, The Business Intelligence Platform 185, and the Recognition engine 190 together form the Transportations Services Application 150. These elements may be modules that may be implemented using software, hardware, or a combination thereof.

Transportation Services Platform 175 may handle requests for member services at the point of service, such as a parking garage, for example requests for automated access control, end-to-end parking transaction audit and fraud control, contract management, and automated billing and payments. Loyalty/Rewards Platform 180 may handle the issuing of credits and other rewards by member-businesses and the application of such rewards to member-user accounts. Business Intelligence Platform 185 may gather, manage, and provide business intelligence to member-businesses, which may include information about the member-users utilizing the member-business's credits, such as demographic information, frequency of visitation, types and amounts of purchases made at the member-business location, different businesses and member-business locations frequented by the member-users, etc. The information may also include information about the effectiveness of the credits, how the credits are utilized by the member-users, and/or how the credits offered and credit-usage compares to other member-businesses. Recognition engine 190 may determine a license plate number or QR code or other code from a regular photographic image. It may allow regular cameras to be used to gather license plate and code information, rather than a specialized LPR system or similar.

In one embodiment, the memory 110 may also include a Transportation Services Application 150. The Transportation Services Application 150 may comprise a software application configured to provide the ability for a user to create user accounts, store information regarding the user accounts in a database, purchase time for parking, and customize a plurality of user preferences associated with the user accounts. Accordingly, the server computer 102 may also be coupled to a plurality of databases 195, 197 which may include a relational database 195 that is queried using an SQL query, and/or an XML database 197 queried using an XML query. Embodiments of the instant invention, however, are not limited to any particular physical database storage mechanism and may readily be extended to operate on other such mechanisms, whether currently known or unknown. While the databases 195 and 197 are illustrated as being external to the server system, it is noted that the databases 195 and 197 may exist on a local storage device (e.g., storage device 140) of the server computer 102, or may be accessed over the network 700.

The Transportation Services Application 150 may be communicatively coupled to at least one of the CRM system 155, the ERP system 160, the NMS 165, the billing/payment system 175, the Transportation Services Platform 175, the Loyalty/Rewards Platform 180, The Business Intelligence Platform 185, and/or the Recognition engine 190 to facilitate user account creation and customization and payment for parking spaces, transportation rewards, and or management of transportation service locations.

The NMS 165 may be used to monitor and administer traffic on the network 700. The NMS 165 may be a combination of hardware and software. The NMS 165 performs a plurality of tasks, which include, but are not limited to, discovering network inventory, monitoring the health and status of devices connected to the network 700, and providing alerts to conditions that impact system performance. The NMS 165 also allows for the remote management of local operations by a centralized operation.

As shown, the server computer 102 is also coupled (via the network 700) to a cellular gateway 710, a short messaging service (SMS) gateway 720, and a credit card gateway 730. The cellular gateway 710 acts as an interface between a local computer (e.g., client computers 202, 302, 402, 502) and a remote computer (e.g., server computer 102) through a cellular data connection. The cellular gateway 710 provides high performance wireless TCP/IP data communications via cellular networks, for connectivity to remote sites and devices (e.g., the server computer 102).

The SMS gateway 720 facilitates SMS transit by either transforming messages to mobile network traffic from other media or by allowing transmission or receipt of SMS messages with or without the use of a mobile phone. In other words, the SMS gateway 720 can be used to transmit SMS messages between a client computer (e.g., 202, 302, 402, 502) and the server computer 102.

The credit card gateway program 730 may be configured to transfer payment information entered using the client computer 102 to the server computer 102 (via a credit card processing interface 122 and the billing system 180) connected via the network 700. For example, a server maintained by an acquiring bank (i.e., a bank that accepts credit and/or debit card payments on behalf of the merchant) and a server maintained by an issuing bank (i.e. the bank that offers the credit and/or debit card directly to the consumer) may also be connected to the network 700. The acquiring bank's server may execute a payment processor program, which facilitates communication between the acquiring bank and an issuing bank. The issuing bank's server may execute also execute a payment processor program, which may approve or decline the transaction.

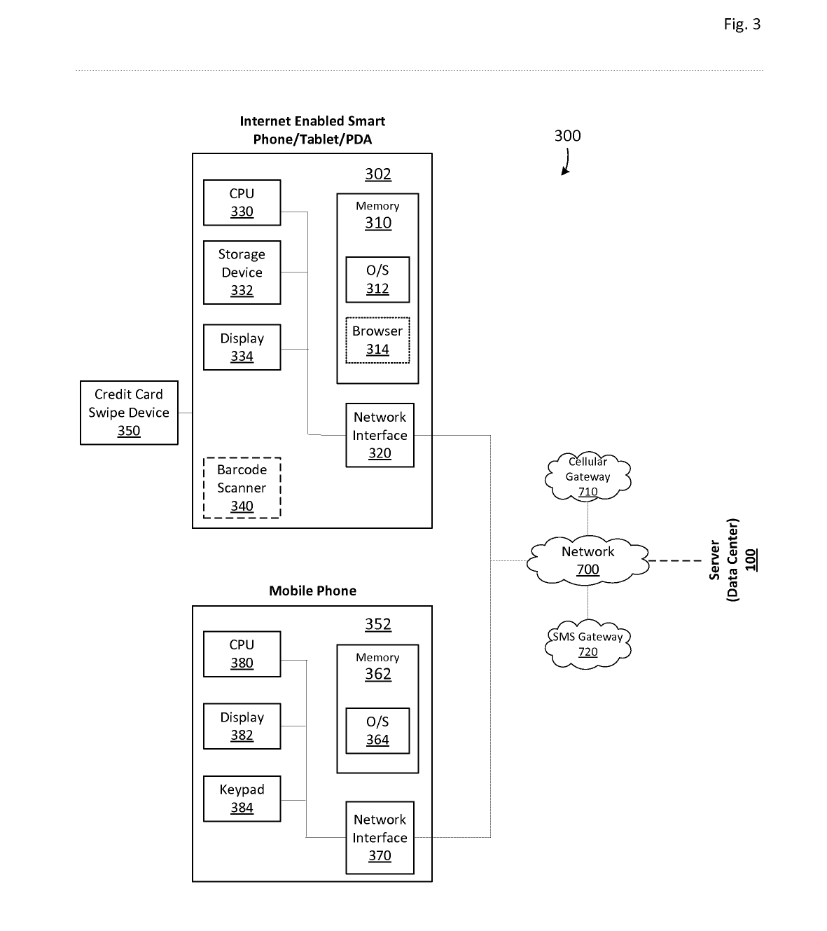

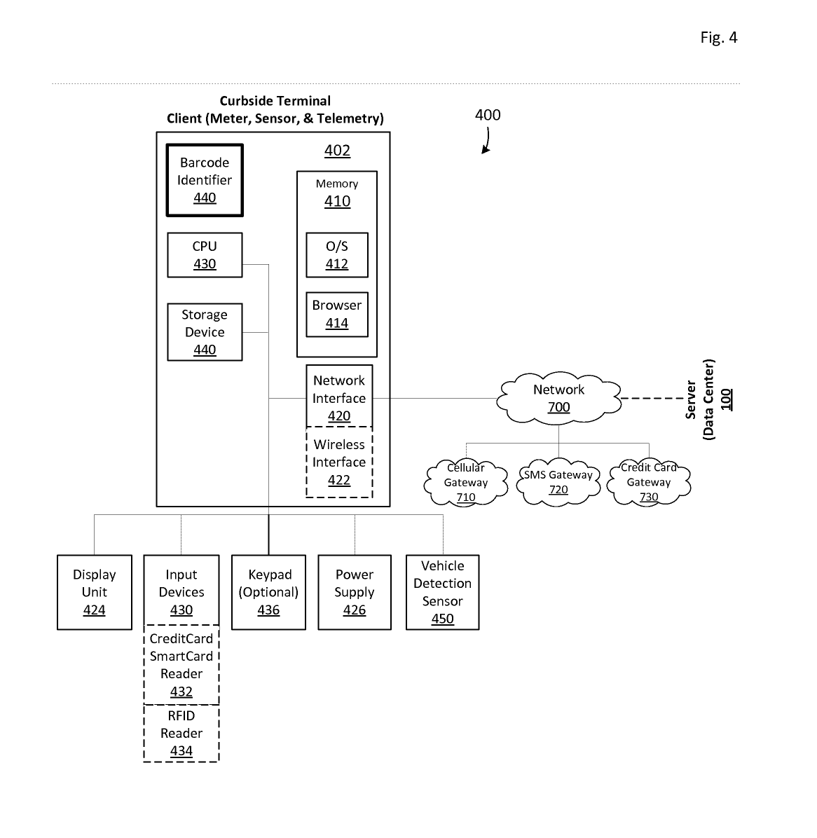

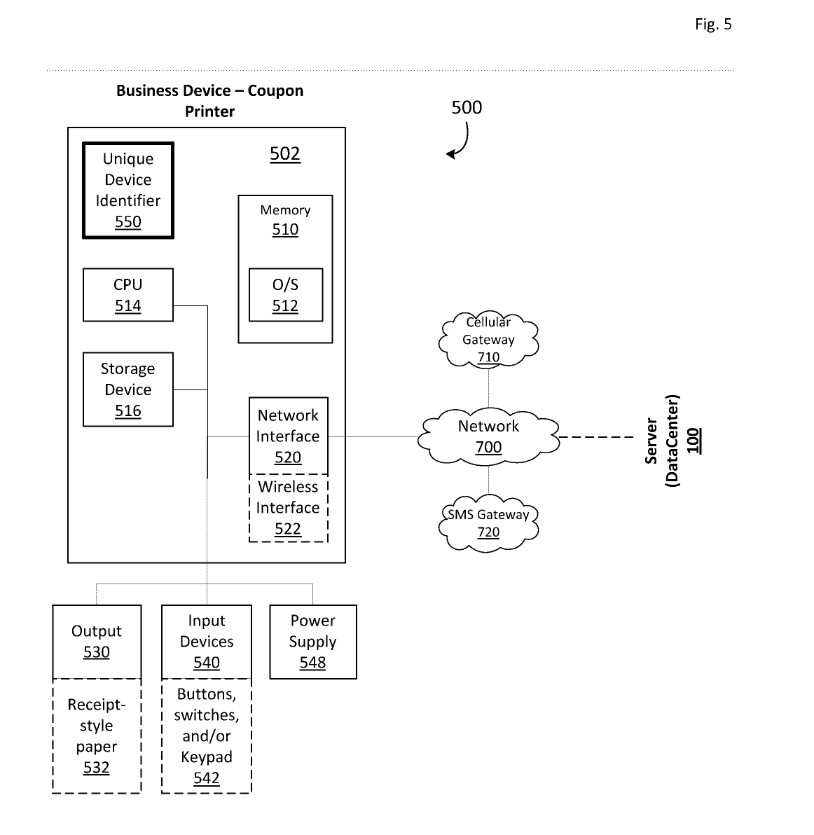

The server computer 102 may be coupled to a plurality of client computers. For example, as shown in FIG. 2, the server computer 102 is coupled to a government, consumer and/or business portal 202. As shown in FIG. 3, the server computer 102 is further coupled to an Internet-enabled Smart Phone/Tablet/PDA 302, with or without an adjunct credit card swipe device 350, and a mobile phone 352. As shown in FIG. 4, the server computer 102 is further coupled to a curbside terminal. As shown in FIG. 5, the server computer 102 is further coupled to Business Credit Device 502. Each of these client computers, 202, 302, 352, 402, 502 and their associated functionality may include similar components (e.g., a CPU, a memory, a storage device, a network interface). Therefore, description for these common components is only given with reference to FIG. 2.

Turning now to FIG. 2, a block diagram illustrating an exemplary computing environment 200, in accordance with an embodiment of the present invention, is illustrated. Specifically, a client computer (e.g., a government, consumer and/or business portal) 202 is shown coupled to the network 700. As shown, the portal client 102 may include a central processing unit (CPU) 230 connected to a memory 210, a storage device 240, and a network interface 220 via a bus. The CPU 230 may be included to be representative of a single CPU, multiple CPUs, a single CPU having multiple processing cores, and/or the like. The storage device 240 may store application programs and/or data for use by the client computer 102. Examples of the storage device 240 may include one or more hard-disk drives, flash memory devices, optical media and/or the like. The portal client 102 may be connected to the data communications network 700 (e.g., a local area network (LAN), which itself may be connected to other networks such as the Internet) using the network interface 700. The memory 201 can be one memory device or a combination of memory devices, including a random access memory, a nonvolatile and/or backup memory (e.g., programmable or flash memories, read-only memories, etc.).

Illustratively, the memory 210 of the portal 202 may store an operating system (O/S) 212 that may be used to manage hardware and/or software executing on the portal 202. As shown, memory 210 may also include a browser program 214 that, when executed by CPU 230, may provide support for navigating between various servers and/or locating network addresses at one or more servers (e.g., server computer 102). In one embodiment, users may interact with the server computer 102 using a graphical user interface (GUI). In a particular embodiment, the GUI content may comprise HTML documents (i.e., web pages) rendered on a display unit 250 coupled with the portal 202 using the browser 214. In one embodiment, the web pages may include pages that allow a user to purchase time for one or more parking spaces and/or manage user accounts associated with one or more parking spaces. In this case, the browser program 214 may access a plurality of member-user profiles that may have linkages to a single Transportation Replenishing Member Payment Account (TRMPA) for purposes of managing family and/or fleet operations from a single payment account.

The portal client 102 may be connected to one or more display units 250, input devices 260, output devices 270 and/or peripheral devices 280. The display units 250 may be internal and/or external monitors, television screens, handheld device displays, and/or the like. The input devices 260 may be any one of a keyboard, a mouse, a track-ball, a stylus, a mouse pad, a mouse button, a joystick, a scanner, a microphone and/or the like. The output devices 270 may be any one of a monitor, a printer, a plotter, a copier and/or any other output device. The peripheral devices 280 may be any other device that can be coupled to a computer: a CD/DVD drive capable of reading and/or writing to physical digital media, a USB device, a flash memory “thumb” Drive, an external floppy drive, an external hard drive, a phone and/or a broadband modem, a router/gateway, an access point and/or the like.

The portal client 202 may be used to create and/or customize user account profiles for the parking meter system and purchase time for parking spaces associated with the parking meter system. Using the portal client 202, users may interact with the server computer 102 using a graphical user interface (GUI). In a particular embodiment, the GUI content may comprise HTML documents (i.e., web pages) rendered on the display unit 250 coupled with the client computer 202 using the browser 214. The web pages may include pages that allow users to create user accounts, customize user accounts, locate member network-garages or parking spaces, and purchase time for parking. Such web pages may include, but are not limited to a “Pay” page, a “Maps” page, a “My Location” page, an “Offers” page, a “Redeem” page, an “Account Preferences” page, and a “My Bills and Reports” page, all of which are related to the enrollment for, use and tracking of, billing and/or payment for Transportation and Transportation Support Services and/or credits/rewards that apply to Transportation and Transportation Support Services, and are discussed below.

In one embodiment, a user may establish a Transportation Replenishing Member Payment Account (TRMPA). The TRMPA is a member-created local financial repository and acts as the source for debit-style payments for parking and/or other transportation related services in addition to the repository of funds or credits that may be applied to the user from outside entities such as businesses. In one embodiment, the user may be identified to the Transportation Service Entity (e.g. parking meter system or parking garage/location) by a mobile application (mobile “app”), a Custom Debit/Smart Card, a cell phone and/or various radio-frequency identification (RFID) methods or License Plate Recognition (LPR) methods known in the art. Once a user is identified, the Transportation Services System may invoke pre-defined billing processes and/or invoke custom member services.

The TRMPA is created through custom CRM 155 and ERP 160 (shown in FIG. 1) software applications and accessed through the portal client 202. The user creates an account and establishes a unique TRMPA. Preferences are made available for secure methods for which to load/re-load this TRMPA with funds from sources such as credit cards, bank account transfers, and/or the like. Tokenization from data processing companies accessed through the Credit Card Gateway 730 and the Billing/Payments system 170 ensure the security of these transactions by minimizing or removing records of actual account numbers from the service provider.

Preferences are also established when establishing the TRMPA. For example, a user may set minimum financial thresholds, automate the refilling of funds and/or the sources of funds, and the like. In one embodiment, the user may also set a preference that leaves the TRMPA with a balance of zero. In this case, the user elects to use the account solely to invoke member services and chooses on-site payment of coin currency.

User account preferences also include establishing methods of identification of the user at a curbside terminal 402 (shown in FIG. 4) when paying for a parking space (or spaces). Once a member-user has been initially identified, further identification can be carried out per the member-user's preferences, for example if dual-factor authentication is used or if the member-user must be identified again when making payment, checking out of a parking garage, etc. Turning now to FIG. 4, a block diagram illustrating a curbside terminal coupled to a network, in accordance to one embodiment of the present invention, is shown. A curbside terminal 402 may be a parking meter kiosk, sensor, controller and/or a point-of-service (POS) system (e.g., a curbside parking system and/or parking garage facility). The curbside terminal 402 may be coupled to the network 700 via a wired (e.g. using wired internet telemetry) or a wireless connection (e.g. via wireless interface 422). The curbside terminal 402 may also include a unit-specific barcode (or other unique readable identifier) 440 (described further below).

As shown, the curbside terminal 402 may be coupled to a display unit 424, input devices 430, a keypad 436, a power supply 426, and a vehicle detection sensor 450. In one embodiment, the display unit 424 may be a liquid crystal display (LCD) or the like, that displays messages to a user. In one embodiment, the input devices 430 may include a coin slot and/or a counter. The coin slot accepts coins for payment for the parking space. The counter maintains the time remaining for the parking space. The input devices 430 may also include a credit card/smart card reader 432, a radio frequency identification (RFID) reader 434, and a authentication keypad 436, which are described further below. The power supply 426 may supply power to the curbside terminal. The vehicle detection sensor 450 may detect whether or not a vehicle is occupying a parking space.

When using the curbside terminal 402 for parking, a user may be identified by the curbside terminal via a Custom Debit/Smart Card, specialty credit card/smart card, LPR identification, RFID identification, a mobile application, and/or a cell phone. The user may choose the method of identification by updating his or her user preferences using the parking meter system portal. Each of these four methods of identification is further described below.

A Custom Debit/Smart Card uses traditional magnetic card swipe technology and coding standards in credit card capable CST meters. As shown, the CST 402 is coupled to Credit Card/Smart Card Reader 432, which reads and processes the magnetic strip of the Custom Debit/Smart Card. The Custom Debit/Smart Card authorizes debits from the associated TRMPA from pre-authorized merchants, or in this example, authorized CSTs 402 or parking meters. The Custom Debit/Smart Card's use pre-established credit card gateways 730 and processes and identify the TRMPA as the bank from which to withdraw funds and identify the user as the account-holder, thereby invoking the predefined member-services. Upon authorization approval, the user may add time to the device manually using an on-site CST keypad 436. If the TRMPA balance is zero, member-services are invoked and on-site coin payment processes are required.

To implement RFID identification, the CST 402 may be coupled to the RFID reader 434. In this case, a user may transmit an RFID identifier via a device (e.g., an RFID key-ring token or the like, a smart card, cell phone 402, 452, or any other device suitable for radio frequency transmission) for the RFID reader 434 to receive. Once the RFID reader 434 translates the signal into a RFID identifier number, it is processed for approval authorization, and upon approval, time can be applied to the CST 402 or MSC and member-services are invoked. If the TRMPA balance is zero, member-services are invoked and on-site coin payment processes are required.

The amount of system processing performed by the CST versus the remote computing device (e.g. server computer 102) can vary in different embodiments. In some embodiments, the CST may only detect the presence of a vehicle and transmit that information to a remote computing device, along with some way of identifying the originating parking space, with everything else done directly by the remote computer using e.g. a mobile phone app/internet portal. In such embodiments, the CST need not have a user interface or even be visible to users. In other embodiments, substantial processing can be performed locally by the CST. Generally, all of the processing tasks can be done locally or remotely or a combination thereof.

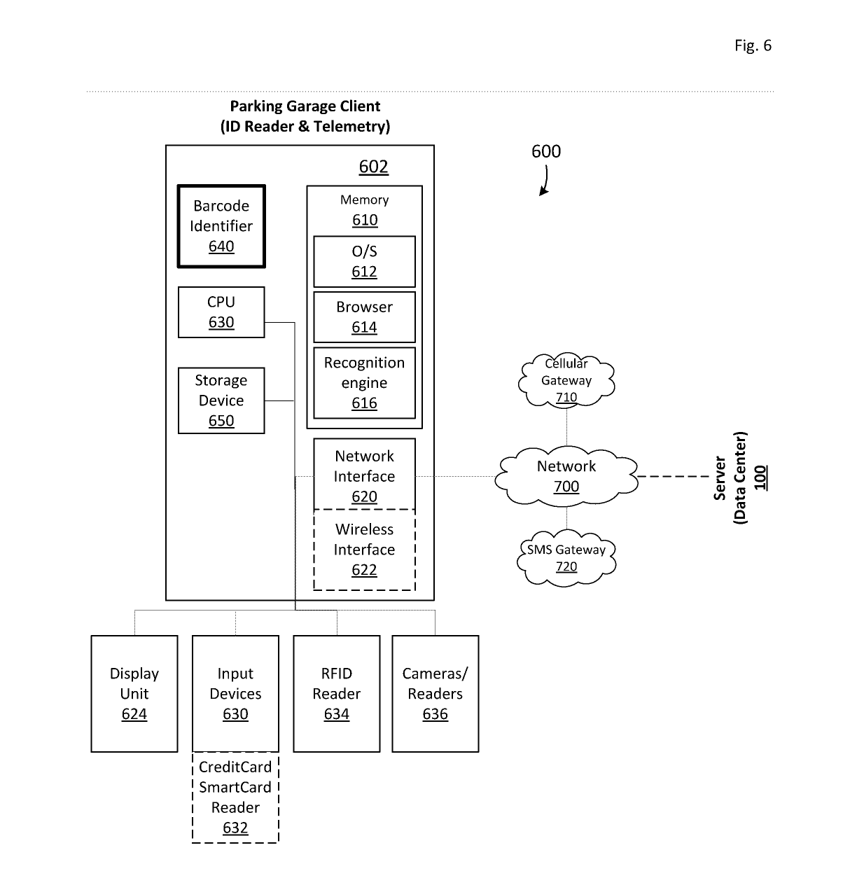

As shown in FIG. 6, the Parking Garage Entity 602 may be coupled to a display unit 624, input devices 630, an RFID Reader 634 and/or a License Plate Camera/Reader (LPR) 636. In one embodiment, the display unit 624 may be a liquid crystal display (LCD), a message board, signal lights or the like, that displays messages to a user. The input devices 630 may also include a credit card/smart card reader 632, a radio frequency identification (RFID) reader 634, Near-Field Communications (NFC) device or the like which are described further below.

When using the Garage location 602 for parking, a user may be identified by the system via specialty credit card/smart card, LPR identification, RFID identification, a mobile application, Mirror/window tag, barcode, and/or mobile phone/tablet. The user may choose the method of identification by updating his or her user preferences using the Transportation System Application portal. Each of these methods of identification is further described below.

A Custom Debit/Smart Card uses traditional magnetic card swipe technology and coding standards in credit card capable parking garage locations. As shown, the parking garage 602 is coupled to Credit Card/Smart Card Reader 632, which reads and processes the magnetic strip of the Custom Debit/Smart Card. The Custom Debit/Smart Card authorizes debits from the associated TRMPA from pre-authorized merchants, or in this example, authorized parking garage 602. The Custom Debit/Smart Card's use pre-established credit card gateways 730 and processes and identify the TRMPA as the bank from which to withdraw funds and identify the user as the account-holder, thereby invoking the predefined member-services.

To implement LPR, RFID, or NFC identification, the parking garage 602 may be coupled to the LPR camera 636, recognition engine 616, NFC, or RFID reader 634. In this case, a user may transmit an identifier via a device (e.g., an RFID key-ring token or the like, a smart card, cell phone 602, 652, or any other device suitable for radio frequency transmission) for the RFID reader 634 to receive. For LPR 636 identification, a member-registered license plate is read by LPR cameras 636 and correlated for identification and processed for approval/payment and member-services are invoked. Once the RFID reader 634 translates the signal into a RFID identifier number, it is processed for approval authorization and member-services are invoked. License Plate Recognition accuracy may be dramatically increased through the use of multiple cameras, LPR engine(s), and/or capture of multiple images across an entry and/or exit process. Comparisons of images captured within a similar timeframe from differing angles may result in differences, allowing for the identifiers to be corrected or corroborated manually or automatically, both locally and/or remotely, and both in real-time and/or off-line.

Mobile applications are a powerful means of conveniently invoking identification and member services. Turning now to FIG. 3, a block diagram illustrating mobile devices 302, 352 coupled to a network 700, in accordance to one embodiment of the present invention, is shown. Mobile applications executing (for example, on CPU 330 of an Internet-Enabled Smart Phone/tablet/PDA 302 or CPU 380 of Mobile Device 352) are related to the TRMPA through secure processes that include “registration, reply, and response” processes that include Mobile Identification Number (MIN), Electronic Serial Number (ESN), Automatic Number Identifier (ANI), Media Access Control (MAC) addresses, and/or other identification specific to the mobile device (e.g., 302, 352). The user can also choose to enter their specific user account number and a predefined PIN code.

Mobile applications may also be a means of accessing the user account through a local browser or preconfigured “applet” shortcuts to perform more sophisticated administration and control. In this example, the user ID and password may serve as authentication of identification and allow access to member-user services.

When using mobile applications, a CST 402 (shown in FIG. 4) specific-identifier may be available for a member-user to enter into a mobile application using one of several possible techniques: for example, manual entry or barcode scanning. When using manual entry, the parking space's Block ID and/or Space ID are manually entered into the mobile application and submitted for authorization. A Space ID may identify a specific parking space within a block or parking area, while a Block ID may be used for parking areas divided into blocks, e.g. Block A, Block B, etc.

When using barcode scanning, the CST 402 or parking garage 602 may include the barcode identifier 440/640 (shown in FIGS. 4 and 6). The barcode 440/640 may be scanned and submitted for authorization. This CST or parking garage-specific barcode 440/640 may include both the Block and Space IDs. Multi-space parking controllers (MSC) may use a group barcode that simply identifies the Block ID. In either case, the barcode may be scanned via a mobile barcode scanner 340 coupled to the Internet-Enabled Smart Phone/PDA 302 and/or the Mobile Phone 352, and the mobile application requests the appropriate space ID for manual entry. In multi-space applications, space-specific barcodes may be applied directly to the space for more convenient processing (which may include both Block ID and Space ID).

Upon receipt of both the User-Identification information and the CST and/or space identification, the user can either add time using the on-site CST keypad 436 for single-space CSTs 402 or add time via the mobile application for both single-space CSTs 402 and Multi-space Controllers for the specific Block ID/Space ID. In the example of a single-space curbside terminal, the system software communicates the added time to the curbside terminal to display locally.

Barcodes or QR codes may also be used to identify the user to the Site and/or system. Upon entering a location, a user's smart-phone/tablet may offer a QR code that may be scanned, signalling the start of processes, such as valet car delivery and/or payment of services.

When using cell phones 302, 352 for identification, the cell phones 302, 352 may be related to the TRMPA using the cell phone's MIN, ANI, ESC or the like. This phone number identifier may be included in the user's preferences and permits the user to call a predefined telephone number and manually enter the Block & Space IDs. Once authorized, time can be added to the CST 402 and the TRMPA will be debited. If the TRMPA balance is zero, member-services are invoked and on-site coin payment, auto-reload, and/or other processes are required.

In one embodiment, a user account TRMPA may be replenished using transportation or “parking credits/rewards.” Traditional businesses occasionally use a type of “customer award” strategy, offering “parking validation” to customers who purchase goods and/or services and park vehicles in “paid-parking” locations with a relationship to the business. This “validation” serves to subsidize part or all of the cost of parking the vehicle during the period of shopping. These offers may be limited to specific parking facilities that have a process for managing the relationship and financial processes between the facility, business, and customer.

Referring again to FIG. 2, the following is a description of apparatus, systems, and methods that may be deployed to establish a process for businesses to offer credits/rewards. Like consumer customers, businesses may create an account and register via a custom CRM application through a Business Services Portal 202. This process accesses the Transportation Services Application 150 using modules such as CRM 155 and ERP 160 processes (as shown in FIG. 1) and includes entering business details such as name, address, and/or the like, in addition to establishing payment accounts and preferences such as bank accounts, credit cards, and/or the like.

Through the Business Services Portal 202, member-businesses may have access to powerful controls that allow them to customize offers such as parking credits, targeted-marketing offers, and/or advertising (for example through CSTs 402 or mobile applications executed on Internet-Enabled Smart Phone/PDAs 302). These controls provide the business the ability to define a given business-neighborhood through the radius distance from the business location, proximity to business location, frequency of visits to the defined business-neighborhood, etc. Additional controls available include controls to define the parking-credit term, number of offers, view the anticipated cost impact based on historical submissions, etc.

The member-business may become eligible to produce and distribute credits/rewards by acquiring and registering a Business Credit Device 502. This registration may consist of recording the device ID (e.g., a MAC address) of the Business Credit Device 502 in the Business-User account through the CRM 155 and ERP 160 systems (as shown in FIG. 1), or the device may be registered and be made available for use by logging in to an Internet portal with the business-member's secure username and password (or similar), where codes may be generated and printed in a predetermined secure format. In one embodiment, a single Business Credit Device 502 may be registered with one Business-User account at a time. In another embodiment, multiple Business Credit Devices 502 may be registered with a Business-User.

Turning now to FIG. 5, a block diagram illustrating a Business Credit Device 502, in accordance with an embodiment of the present invention, is illustrated. The Business Credit Device 502 is shown coupled to the network 700. The Business Credit Device 502 may be connected to the data communications network 700 (e.g., a local area network (LAN), which itself may be connected to other networks such as the Internet) using the network interface 520 or the wireless interface 520. As shown, the Business Credit Device 502 may also store a unique device identifier 550. The unique device identifier 550 may be stored in either the storage device 516 and/or the memory 510.

The portal client 102 may be connected to one or more input devices 540, output devices 530 and/or a power supply 548. The input devices 540 may be any one of a keyboard, a mouse, a track-ball, a stylus, a mouse pad, a mouse button, a joystick, a scanner, a microphone, or a combination of one or more buttons, switches and/or a keypad 542 and/or the like. The output devices 530 may be any of a monitor, a printer, a plotter, a copier, and/or any other output device. In one embodiment, the output devices 530 may be configured to output receipt-style paper 532.

The Business Credit Device 502 may be a device and/or a Point-of-Sale (POS) integrated system that may be utilized by businesses to support a business request for a credit/reward from the custom Customer Relationship Management (CRM) 155 and Enterprise Resource Planning (ERP) 160 software applications (as shown in FIG. 1). This process may be invoked by initiating a request for credit (e.g., pressing a “Request Credit” button on a simple stand-alone device, e.g., the Business Credit Device 502). Subsequently, the Business Credit Device 502 invokes a transmission of a short data message-stream across a wired or wireless network (e.g., via the network 700 and the SMS Gateway 720), which may include the unique device identifier 550 and/or a predefined IP address (e.g., the IP address of the server computer 102) coupled through the Transportation Services Application 150 to the CRM 155 and ERP 160.

Upon receipt, the CRM 155 performs a lookup function to determine if the unique device identifier 550 and/or business-member User ID and Password belongs to a registered Business-User Account. If a registered account relationship is not identified, a reply of “DENIED” is returned to the Business Credit Device 502 without a valid coupon or code. However, if a registered Business-User account is identified, a transaction is established and various data is cataloged. For example, system-created information and business-user defined information is cataloged. System-created information may include the date and time of the transaction and/or the credit request transaction ID code (CRT-ID). Business-user defined information may include the business-user name, the specific business address, and/or the business-user defined offer (e.g., $0.50 reward to be applied to TRMPA″).

The Credit Request Transaction ID (CRT-ID) code is transmitted back to the Business Credit Device 502 and invokes a receipt printer 530 to print a paper coupon 532 containing the Business Name, Business Address, Summary of Business offer, Barcode of the CRT-ID, and/or the alpha-numeric version of the CRT-ID.

Upon receiving a Parking Credit coupon, a member-user may have options for applying the credit against their account balance: mobile application scanning and manual entry. When using mobile application scanning, a CRT-ID barcode, QR code or similar (e.g. printed on the small paper coupon 532) is scanned by the barcode scanner 340 coupled to the mobile device 302, 352 (as shown in FIG. 3). In this case, the CRT-ID is transmitted directly to the CRM 155 and ERP 160 for processing once the barcode is scanned.

When using manual entry, the member-user manually enters the alpha-numeric CRT-ID into the member-user account via a Consumer Portal 202 (as shown in FIG. 2), or via a mobile application or web site accessed via a mobile device 302, 352 (as shown in FIG. 3).

In one embodiment, the CRM 155 and the ERP 160 may use pre-defined system-wide business rules (e.g., transactions that start or end within +/−1.5 hours of CRT-ID timestamp) to determine if the record of a member-user parking transaction is within the accepted window of time marked by the CRT-ID issuance timestamp. If a record of a parking transaction was found for the member-user, the terms of the coupon are applied, and appropriate credit is applied to the member-user's Transportation Replenishing Member Payment Account (TRMPA). The issuing business is debited the appropriate amount, and all records are updated for ultimate appropriate payments to the local government. In one embodiment, the appropriate amount may be limited to the actual-time or cost of the transportation service transaction vs. the maximum-time defined with the offer (e.g., “Up-to” 60-minutes of credit for a parking transaction of 43 minutes or a limit of $5.00 credits (total) for a daily transportation service total of $5.00). All detail of transportation service transaction(s), user, and business parking credit(s) are cataloged and stored as a billing record element. Businesses may also use rewards as a mechanism to brand themselves by customizing the use of rewards provided (e.g. “Green Rewards” might only be eligible to be applied to payment for mass transportation, car-share, or bike-share services).

If no transportation service transaction is found that falls within the predefined window marked by the CRT-ID, the credit may be considered invalid, resulting in no credit being applied, and all records are updated as appropriate. However, this may be flexible to adapt to business models that allow a portion and/or all rewards to apply to member accounts regardless of recent transportation transactions.

In one embodiment, the transportation services payment system and method may also provide for local government special treatment pricing. For example, a TRMPA may introduce controls for local governments through the utilization of user profile information established within the member-user account, geographic location, functional use, etc. Examples of this type of special treatment include discounted pricing for senior-citizen constituent, low-income citizen, loading zone deliveries, economic development zones, etc. Thus, a myriad of pricing products become possible based upon member-user profiles and/or additional parameters (time-of-day, birthday treatment, etc.). Special profile elements such as user-age can be confirmed through secure linkages to government databases such as Dept. of Motor Vehicles as appropriate.

As previously described, a member-user account may be associated with a plurality of member services. Such member services include, but are not limited to, user-defined payment and billing services, generic and/or user-defined maps, user-defined communications, user-defined parking meter and parking space controls, user-specific and/or group offers, user-specific information reports, and user linking These member services may be part of and accessible using the member portal program.

A member-user may access the user-defined payment and billing services using a browser program (e.g., 214, 314, 414) of the associated device (e.g., 202, 302, 352, 402). For example, using the browser program (e.g., 214, 314, 414), a user may navigate to a website address associated with the parking meter portal program. Initially, the user may be directed to log in or create an account with the parking meter program via a “Log-In” page. Once the account is created and/or the user logs into the member portal, the user may be taken to the user's “My Home” page. Here, the user may be able to access the member services previously mentioned. For example, a user may access the user-defined payment and billing services on the “My Preferences” and/or “My Bill and Reports” pages. A user may access the generic and/or user-defined maps and/or bookmarked maps via the “My Maps” page. A user may access the user-defined communications via the “My Notifications/Alerts” and/or the “My Preferences” pages. A user may access the user-defined controls on the “My Preferences” pages. A user may access the user-specific and/or group offers via the “My Offers” and/or “My Preferences” pages. A user may access the user-specific information reports via the “My Bills and Reports” page. Finally, a user may access the user linking options via the “My Preferences” pages. Member-user pages are related to the enrollment for, use and tracking of, billing and/or payment for, Transportation and Transportation Support Services and/or credits/rewards that apply to Transportation and Transportation Support Services.

A registered user may also have access to a meaningful “home” page that contains one or more of typically frequently accessed features such as generic and/or bookmarked maps, account status, miscellaneous and parking meter/parking garage controls, parking-credit redemption, etc.

User-defined payment and billing services may include predefined account linking for TRMPA payments. In this case, a user may establish an TRMPA with a predefined amount of funds that is automatically depleted as a user uses transportation services. Upon reaching a predefined threshold level, the TRMPA is automatically refilled with a predetermined amount of funds using an account (e.g., credit card accounts, bank accounts, and/or the like) linked to the TRMPA. Other user-defined payment & billing services may include preferences for manual payment and/or automated payment (as described above). Yet another user-defined billing service may include billing controls for a “Super User,” which has access to a plurality of linked TRMPAs and/or multiple users. A user may access and/or customize these services using a browser program on the associated device.

Generic and/or User-defined maps and/or bookmarked maps may contain predefined data elements such as parking spaces, “Member-network” garage parking locations, current status of the parking, nearby businesses offering parking credits and/or other offers, rates for the parking, hours of operation for the parking, and the like. The maps may also display user-specific shortcuts and/or user preferences. In one embodiment, a user may be presented, via the browser program (214, 314, 414) an interactive map of any given locale. The map would identify parking spaces (e.g., via an icon, link, button and/or the like) associated with the parking meter system. Each parking space identified on the map would include a plurality of information associated with the parking space (e.g., current status of the parking spaces, rates for the parking spaces, hours of operation for the parking spaces, and the like). The map would also allow a user to create user-specific shortcuts to any given parking space or region, allow the user to mark any given parking space as a “favorite”, and/or allow the user to enter any information (e.g., notes and comments) about the any given parking space.

Map views, both user-defined and other, may share the view with nearby businesses offering parking credits and/or other special offers. Maps may include a pinpoint marker identifying a specific location and nearby registered or non-registered businesses may be displayed by proximity to the pinpoint. Business types and/or offerings may be selected by a filter control.

When invoking zone-type street parking, user-defined communications may include user-specific preferences for notifications and alerts. For example, a user may specify the type of content communicated to the user, the rate or interval at which the content is communicated to the user, and the delivery method (e.g., SMS, e-mail, voice call, mobile app, and/or the like) of the content communicated to the user. The content that is communicated to the user may include, but is not limited to, messages regarding account funds, messages regarding time left on a parking meter, imminent traffic pattern changes, and/or messages regarding the availability of any given parking space.

Zone parking controls may use the TRMPA and user-defined parking timer controls may include remote views of a virtual or actual parking meter currently in use by the user. The remote view may be presented to the user via the browser program 214, 314, 414. The remote view may present the time, payment, rate and allowable time schedules, and/or status of the parking space. The remote view may also include interactive remote control capabilities. For example, a user can make a payment or reload a parking meter remotely rather than having to walk to the meter and refill the meter on the spot.

User-specific and/or group offers may include parking billing account credits, targeted offers based on travel behavior and/or trends. The offers that are delivered may be user-specific or specific. The offers may also be delivered to any given member, members associated with a certain group, or non-members.

User-specific information reports may include billing reports and utilization reports. The information reports may also be tailored for an Individual User or a Super-User. Billing reports may include a summary of charges to the TRMPA, the amount of funds remaining in the TRMPA, and/or the like. Utilization reports may include information regarding the usage of the parking spaces and/or parking areas used for any given time period.

User linking services may allow a user to link a plurality of users and/or TRMPA accounts that are authorized to use the member services for purposes such as a “Super User Account”. Super User Accounts may be established for fleet management, family usage, and/or the like. Information communicated through one or more of the methods and/or devices described in FIGS. 1 through 6 may support the capability to perform more complete data mining to include, but not limited to, individual, group, and or space usage, utilization, transportation patterns, behavioral patterns such as violations, payment, travel patterns, time-in-locations, etc. Consumer member applications & services available through the accumulation of information of user payment, sensor vehicle detection, etc. include but are not limited to the following:
a. Flexible member payment methods leveraging the Transportation Replenishing Member Payment Account (TRMPA) offering choice of easy payment methods such as but not limited to:
   i. LPR, NFC, and/or RFID Identification
   ii. Mobile Application
   iii. Cell payment
   iv. Specialty credit/debit card (credit card recognized by only authorized merchants such as the related meters and debit the member account—thereby triggering the downstream member services such as pre-defined alerts, etc.)
b. Occupancy maps reflecting either generic, user-specific, and/or bookmarked maps with space availability, nearby businesses with offers such as deals, coupons, or parking validation services, and/or other related detail.
c. Ability to enter credit codes used to apply payment credits to TRMPA.
d. Generic and customizable alerts reflecting pre-defined or custom messages, time-intervals, and form-factors (e.g. SMS text, email, automated voice, etc.)
e. Parking-Space Interactivity reflecting the ability to remotely add time through the debiting of the TRMPA. This interactivity can be triggered either manually or automated using pre-defined business rules (e.g. within 5-minutes of expiration adds a minimum of 30 minutes of time and debits TRMPA).
f. Member-specific and/or fleet management reports reflecting billing/payment, travel behaviors, credits, travel, utilization, etc.
g. Proactive Parking Directions triggered through a user-defined destination and anticipated arrival time interval (e.g. 3-minutes, 6-minutes, 9-minutes). Results may offer the best option for street, direction, and/or specific location and may offer option to accept results or “snooze” function to re-calculate in a pre-defined period of time with new results. The directions may be calculated by but not limited to using an algorithm including the follow:
   i. Spaces nearest chosen destination
   ii. Space availability
   iii. Time remaining on meters by member vs. non-member occupied (i.e. Non-members likely will not remotely add time)
      Business applications & services may offer full and/or parking payments in the form of credits that may be applied to members' TRMPA. Membership to businesses may be introduced through payment of a registration fee and supply of pertinent information (e.g. name of business, address of business, payment methods such as credit card or bank account, and identification of coupon generating device(s), number of devices, coupon limits, etc.). The Business member service offers the ability to choose offers, time and/or days-of-week of offer, etc. A Business Member Dashboard may be available reflecting pertinent details for the business manager, such as time-in-space of patrons that submitted a business offer and locations & occupancy of nearby spaces with submitted coupons from other businesses. The system may also collect survey information from patrons reflecting businesses they would like to see offering business credits and/or offers. All consumer and/or fleet services and applications described may be available through cellular internet-capable navigation systems such as those found in automobiles. “Services” may also refer to “software applications” or “applications”.

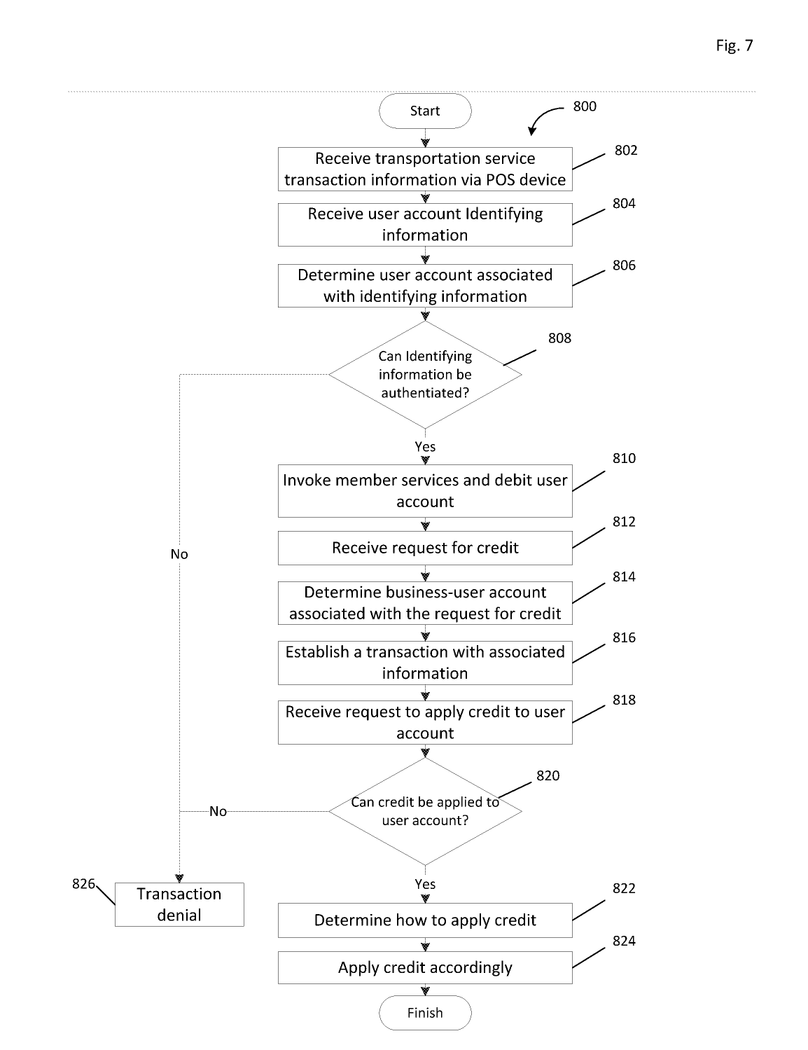

FIG. 7 illustrates a method for processing payment for transportation services and concomitantly invoking user-defined member services and processing payment credits from participating businesses. The operations of method 800 presented below are intended to be illustrative. In some embodiments, method 800 may be accomplished with one or more additional operations not described, and/or without one or more of the operations discussed. Additionally, the order in which the operations of method 800 are illustrated in FIG. 7 and described below is not intended to be limiting.

In some embodiments, method 800 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 800 in response to instructions stored electronically on an electronic storage medium. The one or more processing devices may include one or more devices configured through hardware, firmware, and/or software to be specifically designed for execution of one or more of the operations of method 800.

At an operation 802, information pertaining to a transportation service transaction may be received via a transportation service provider point-of-service device. As examples, the identifier of a recently occupied parking space may be received from a curbside terminal, or a vehicle may have entered a specific parking garage facility and the vehicle's license plate captured via an LPR device. At an operation 804, user account identifying information associated with the transportation service transaction may be received. For example, a user account identification code may be received from the curbside terminal, or a license plate image or RFID information may be received from the curbside terminal or parking garage faciltity, which may be used to determine a user account identification code. In other implementations, identifying information such as a registered mobile device ID or user ID and password may be received directly from a user.

At an operation 806, a user account associated with the user account identifying information may be determined. At an operation 808, the user account identifying information may be authenticated. For example, a code received from an RFID or smart card or directly input by the user via a mobile device application may be verified. Responsive to successful authentication of the user account identifying information, at operation 810 one or more user-specific member services associated with the identifying information-associated user account may be invoked and the identifying information-associated user account may be debited to pay for a service provided by the transportation service provider. In implementations, the member services may include user-defined payment method and account replenishment services, user-defined transportation service provider alerts, and/or user-defined parking space controls.

At an operation 812, a request for credit comprising a unique business identifier may be received via a business credit device. For example, a local business may request a transportation credit to give to a customer to compensate the customer for transportation expenses incurred in coming to the business, similar to a parking validation. At an operation 814, a business-user account associated with the unique identifier may be determined. For example, the business-user may have pre-registered the business credit device, associating the business credit device unique identifier with the business-user's account. At an operation 816, a transaction may be established and system-created information and business-user defined information may be associated with the transaction. In implementations, system-created information may include the date and time of the transaction and/or a credit request transaction ID code (CRT-ID), while business-user defined information may include the business-user name, the specific business address, and/or the business-user defined credit offer. The information associated with the transaction may include details of a user account credit.

At an operation 818, a request to apply the credit associated with the transaction to a requested user account is received. For example, a user may scan a credit receipt created by the business credit device and containing a QR-code or the like which includes information specific to the credit reward, using the user's mobile device, automatically requesting application of the credit to the user's account. At an operation 820, whether to apply the credit to the requested user account is determined based on parking services payment transaction information associated with the requested user account. For example, application of the credit may be confirmed if the user incurred transportation expenses near the time and area of the credit transaction. At an operation 822, responsive to a determination to apply the credit to the requested user account, how to apply the credit to the requested user account is determined. For example, the credit may be applied up to a maximum of the actual expense incurred by the user. At an operation 824, the credit is applied according to the determination as to how to apply it to the user account.

Should the identifying information not be authenticated at operation 808, or the credit be determined inapplicable to the user's account at operation 824, the transaction is denied and the process ends.

The invention is not limited to the particular embodiments described above in detail. Those skilled in the art will recognize that other arrangements could be devised, for example, using variously configured user and business devices, transportation service entity systems such as curbside terminals, and parking portal program websites, various identification and encryption methods, and various types and levels of user services, and also in various applications where a space and/or time is reserved, other than parking spaces. The invention encompasses every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application. While the invention has been described with reference to specific illustrative embodiments, modifications and variations of the invention may be constructed without departing from the scope of the invention.

I claim:

1. A transportation services system, comprising:
one or more physical processors; and
storage media storing machine-readable instructions that cause the one or more physical processors to:
receive, via a transportation service provider point-of-service device, information pertaining to a transportation service transaction;
receive user account identifying information associated with the transportation service transaction;
determine a user account associated with the user account identifying information;
authenticate the user account identifying information; and
responsive to successful authentication of the user account identifying information, invoke one or more user-specific member services associated with the identifying information-associated user account and debit the identifying information-associated user account to pay for a service provided by the transportation service provider.

2. The system of claim 2, wherein the machine-readable instructions further cause the one or more physical processors to:
receive, via a business credit device, a request for credit comprising a unique business location identifier;
determine a business-user account associated with the unique device identifier;
establish a transaction and associate system-created information and business-user defined information with the transaction, wherein the information associated with the transaction comprises details of a user account credit;
receive a request to apply the credit associated with the transaction to a requested user account;
determine whether and how to apply the credit to the requested user account based on parking services payment transaction information associated with the requested user account; and
responsive to a determination to apply the credit to the requested user account in a certain manner, apply the credit accordingly.

3. The system of claim 2, wherein the machine-readable instructions further cause the one or more physical processors to:
transmit to the business credit device instructions for generating a coupon comprising information associated with the transaction, including a credit request transaction identification code;
wherein the request to apply the credit is received from a member-user associated with the requested user account and comprises the credit request transaction identification code and member-user identifying information.

4. The system of claim 3, wherein the determination of whether to apply the credit to the requested user account comprises a determination as to whether the requested user account contains a record of purchased parking services in a geographic area and at a time consistent with the information associated with the transaction.

5. The system of claim 4, wherein whether a geographic area and time of a parking service purchase is consistent with information associated with the transaction is determined based on pre-defined system-wide business rules.

6. The system of claim 4, wherein whether a geographic area and time of a parking service purchase is consistent with information associated with the transaction is determined based on rules that are at least in part set by a business-user associated with the business-user account.

7. The system of claim 2, wherein the machine-readable instructions further cause the one or more physical processors to:
apply a debit corresponding to the credit to the registered business-user account; and
catalogue and store details of the credit and debit applied as a billing record element.

8. The system of claim 2, wherein the request to apply the credit is received with the request for credit, at least one of which comprises member-user identifying information.

9. The system of claim 2, wherein the machine-readable instructions further cause the one or more physical processors to:
authenticate a business-user;
associate the unique device identifier with the business-user account; and
receive information from the business-user and associate it with the business-user account.

10. The system of claim 2, wherein the machine-readable instructions further cause the one or more physical processors to:
receive from a business-user and associate with the business-user account information comprising at least one of a designated area in which a member-user must be parked for credit to be applied to the member-user's user account and particular types of transportation services the credit may be applied against; and
using the information when determining whether and how to apply the credit.

11. The system of claim 1, wherein the user account identifying information is received via the transportation service provider point-of-service device and comprises at least one of smart card information, license plate information, NFC identification, a QR code, a barcode, RFID information, or authenticated User name and Password.

12. The system of claim 1, wherein the user account identifying information is received from a member-user, wherein the machine-readable instructions further cause the one or more physical processors to:
receive location-verification information from the member-user;
wherein the location-verification information comprises at least one of information displayed by the transportation service provider point-of-service device and member-user mobile device geographic information.

13. The system of claim 1, wherein the user account identifying information comprises a user account identification code.

14. The system of claim 1, further comprising the transportation service provider point-of-service device, wherein the transportation service provider point-of-service device comprises at least one of an RFID reader, license plate reader, NFC device, and a display comprising encoded identifying information for the transportation service provider point-of-service device.

15. The system of claim 1, wherein the user account identifying information is received from a member-user, wherein the information pertaining to the transportation service transaction comprises information from at least one of an RFID reader, license plate reader, NFC device, and a display of the transportation service provider point-of-service device as set by the member-user.

16. The system of claim 1, wherein the user-specific member services comprise user-defined payment method and account replenishment services, wherein the user-defined payment method and account replenishment services comprise determining whether a predefined threshold level of funds has been reached in the user account and, responsive to a determination that the threshold level of funds has been reached, refilling the user account with a predetermined amount of funds using a financial account linked to the user account.

17. The system of claim 1, wherein the user-specific member services comprise user-defined transportation service provider alerts, wherein at least one of the form-factor of the alerts, time-intervals of the alerts, content of the alerts, and triggers for the alerts are user-defined.

18. The system of claim 1, wherein the user-specific member services comprise user-defined parking space controls configured to remotely add time to a parking space reservation manually or according to pre-defined rules.

19. The system of claim 1, wherein the machine-readable instructions further cause the one or more physical processors to:
receive a request for one or more user-specific member services associated with the identifying information-associated user account and invoke the requested user-specific member services, wherein the requested user-specific member services comprise occupancy maps configured to display parking space locations and availability and nearby business offers.

20. The system of claim 1, wherein the machine-readable instructions further cause the one or more physical processors to:
receive a request for one or more user-specific member services associated with the identifying information-associated user account and invoke the requested user-specific member services, wherein the requested user-specific member services comprise proactive parking directions configured to dynamically direct a user to a specific parking area based on an intended user destination, time to arrival, parking space availability, and expected future parking space availability.

21. The system of claim 1, wherein the machine-readable instructions further cause the one or more physical processors to:
receive a request for one or more user-specific member services associated with the identifying information-associated user account and invoke the requested user-specific member services, wherein the requested user-specific member services comprise at least one of member-specific and fleet-specific management reports displaying travel behaviors, transportation service utilization, and credits received filtered by a time period or other user-defined criteria.

22. The system of claim 2, wherein the machine-readable instructions further cause the one or more physical processors to:
receive a request associated with the business-user account for business user-specific member services and invoke the requested business user-specific member services, wherein the requested business user-specific member services comprise reports displaying information relating to the transportation services utilized by patrons who received credits from the business-user account.

23. A transportation services method, comprising:
receiving, via a transportation service provider point-of-service device, information pertaining to a transportation service transaction;
receiving user account identifying information associated with the transportation service transaction;
determining a user account associated with the user account identifying information;
authenticating the user account identifying information;
responsive to successful authentication of the user account identifying information, invoking one or more user-specific member services associated with the identifying information-associated user account and debiting the identifying information-associated user account to pay for a service provided by the transportation service provider;
receiving, via a business credit device, a request for credit comprising a unique device identifier;
determining a business-user account associated with the unique device identifier;
establishing a transaction and associating system-created information and business-user defined information with the transaction, wherein the information associated with the transaction comprises details of a user account credit;
receiving a request to apply the credit associated with the transaction to a requested user account;
determining whether and how to apply the credit to the requested user account based on parking services payment transaction information associated with the requested user account; and
responsive to a determination to apply the credit to the requested user account in a certain manner, applying the credit accordingly.

24. The system of claim 1, wherein the machine-readable instructions further cause the one or more physical processors to receive, via a plurality of transportation service provider point-of-service devices controlled by a plurality of transportation service providers, information pertaining to transportation service transactions associated with a single member-user, and invoke member services defined by the member-user for each of the transportation service transactions.

25. The system of claim 1, wherein the user account identifying information is received from a user-member, wherein the user account identifying information comprises at least one of a license plate number, an RFID identification number, a mobile phone identification, an NFC identifier, and a barcode or QR-code.
